(19) United States
(12) Patent Application Publication
(10) Pub. No.: US 2005/0147856 A1
(43) Pub. Date: Jul. 7, 2005

(54) Reforming system for a fuel cell

(76) Inventors: Hartmut Albrodt, Tamm (DE); Frank Miller, Ilsfeld (DE); Guenter Hoenig, Ditzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/509,058

(22) PCT Filed: Mar. 18, 2003
(86) PCT No.: PCT/DE03/00876

(30) Foreign Application Priority Data
Mar. 27, 2002 (DE) 10213792.7

(51) Int. Cl. H01M 8/06; B01J 8/00

(52) U.S. Cl. 429/17; 48/127.9; 48/197 R

(57) ABSTRACT

The invention relates to a reforming system for a fuel cell, including an evaporating device for evaporating a raw fuel and for delivering the evaporated raw fuel to a reforming unit, at least one pump for metering the raw fuel that is conducted into the evaporating device, and a control unit. At least one pump is a metering pump, whose rpm is regulated by means of the control unit. Moreover, at least one monitoring device serves to monitor the metering quantity of the raw fuel through the regulated metering pump.

### FIELD OF THE INVENTION

The fuel cell reverses the process of electrolysis. Hydrogen and oxygen are converted directly into water, releasing electrical energy. Because of their low pollutant emissions and high efficiency, fuel cells are used, among other places, in fuel cell vehicles. Fuel cell vehicles are driven by an electric motor, for which the fuel cells furnish the current. Since storing hydrogen directly in tanks is technologically complex, and the construction of a hydrogen infrastructure would involve major costs and problems, on-board generation of hydrogen is an attractive alternative. One possibility for this is the reforming of liquid hydrocarbons, such as methanol (CH₃OH) or (sulfur-free) gasoline.

### BACKGROUND OF THE INVENTION

Liquid fuel (such as methanol, ethanol, gasoline, etc.) in the tank of a fuel cell vehicle must be converted into hydrogen in a reformer. To that end, in the prior art, the methanol, for instance, is mixed with water and evaporated. At temperatures between 250 and 300° C. and with the aid of a catalytic converter, the mixture is broken down into hydrogen (H₂), carbon dioxide (CO₂) and carbon monoxide (CO). In a gas cleaning stage, the highly toxic CO is oxidized with oxygen from the air to make CO₂, and the CO₂ existing in the gas mixture is filtered out, so that pure hydrogen gas reaches the fuel cells. By way of the pressure on the electronic gas pedal and the electronic control system in a fuel cell vehicle, it is determined how much hydrogen is reformed by the reformer from the methanol that is on board.

German Patent Disclosure DE 198 402 16 relates to a reforming system for a fuel cell. It is equipped with a reforming unit, which employs a reaction system that comprises a partial oxidation reaction and a steam reformation reaction as a reformation reaction. This system has an evaporating device for evaporating a raw fuel, for which a mixture solution comprising liquid hydrocarbon, such as gasoline or alcohol, and water is used, and for delivering the evaporated fuel to the reforming unit.

In the reformation in fuel cell vehicles, the metering quantity and the metering precision are of decisive significance. The system is designed for a particular fuel-air mixture. The metering quantity into the evaporator or reformer determines the quantity of hydrogen (H₂) and thus the power that the fuel cell can generate. Only the metering quantity of the fuel (or fuel mixture) can be monitored, but not the individual reforming steps. Excessive fuel metering leads on the one hand to high H₂ development and on the other to high emissions, since at the same time not enough water and/or air for the reforming process is delivered. Inadequate metering leads to a voltage dip at the fuel cell.

In the metering, random pressure fluctuations occur because of the evaporator or reformer. Moreover, the counterpressure increases with an increase in metering quantity per unit of time. Until now, only high-precision laboratory pumps have been used for the metering; these cannot be mass-produced and entail high costs. Such a metering pump, in a normal case, compresses and pumps a fixed volumetric quantity as a function of the rpm. Via the pressure on the electronic gas pedal, the rpm of the metering pump is determined. However, the precision of the metering quantity is not monitored. Possible wear, failure of the pump, or overly low metering, for instance because of an air inclusion, can lead to fluctuations in the metering quantity. The result can be impairments to the system and in an extreme case stoppage of the vehicle.

### SUMMARY OF THE INVENTION

It is an advantage of the embodiment according to the invention that precise metering of a raw fuel for fuel cells is achieved with reforming systems. The metering is accomplished with a precision of less than 2% deviation from the set-point value of the metering quantity.

Incorrect metering, that is, deviations in the metered quantity of raw fuel from its set-point value, can be detected and if needed corrected. For the embodiment according to the invention, components (in particular pumps) in accordance with the prior art, in which only slight modifications have been made, can advantageously be employed. As a result, an economical embodiment that can be mass-produced is presented. These advantages are attained according to the invention by a reforming system for a fuel cell. The reforming system includes an evaporating device for evaporating a raw fuel and for delivering the evaporated raw fuel to a reforming unit. It also includes at least one pump for metering the raw fuel that is conducted into the evaporating device and also includes a control unit. According to the invention, at least one pump is a metering pump whose rpm is regulated. Moreover, at least one monitoring device serves to monitor the metering quantity of the raw fuel through the regulated metering pump.

The reforming of the raw fuel takes place in the reforming unit. The raw fuel may for instance be methanol, ethanol, or gasoline. As the control unit, in the present invention, a control unit known from the prior art and used for instance in automotive technology can be employed.

The monitoring device makes precise metering of the raw fuel possible. It monitors the metering quantity delivered by the metering pump, or variables associated with this, and thereby makes regulation and control of the metering pump possible.

In a preferred embodiment of the present invention, at least one electric fuel pump serves as the metering pump. The electric fuel pump is already used for internal combustion engines in the prior art. Its task is to supply the engine with enough fuel, at the pressure required for injection. Moreover, electric fuel pumps increasingly serve as prefeed pumps for modern direct injection systems, for both gasoline and Diesel engines. One such electric fuel pump is known for instance from German Patent Disclosure DE 199 43 959 A1. In general, electric fuel pumps are constructed in one or two stages as positive-displacement pumps or as flow pumps, and the pump mechanism is as a rule driven via a direct current (DC) motor. The electric motor and the pump mechanism are combined in a housing with an outlet and inlet. The pump mechanism aspirates the fuel through the inlet and then pumps it to the outlet by means of the DC motor. The cooling of the motor is done by the fuel. Typically, DC motors that are externally excited by permanent magnets and are delivered with a voltage of 12V or 24V are used. As pump mechanisms, ring-gear, side-channel, peripheral-channel, vane-cell or roller-cell and screw pump mechanisms are for instance employed. If an electric fuel pump which in the prior art serves to pump fuel in an internal combustion engine is to be used for the reforming system of the invention, then in it the carbon brush shunt must also be protected, and wheels made of special steel must be provided. After these and optionally other modifications, such an electric fuel pump from the prior art is suitable for delivering and metering even such corrosive media as methanol for fuel cells.

Preferably, the rpm of the electric fuel pump is regulated with the aid of a timing module by means of pulse width modulation. The regulation of the rpm and consequently of the volumetric flow of raw fuel is effected by means of high-frequency timing. The timing module in the present invention may be integrated with the control unit or installed separately in the motor vehicle.

In a further preferred embodiment of the present invention, a high-pressure pump driven by an electric motor serves as the metering pump. The high-pressure pump may correspond to a reciprocating piston pump typically used in internal combustion engine technology, optionally modified, such as a 3-cylinder reciprocating piston pump. For delivering fuel to Diesel engines, in-line injection pumps and distributor injection pumps are known in the prior art and can likewise serve as high-pressure pumps in the present invention. As the high-pressure pumps, reciprocating piston pumps embodied as plunger piston pumps or disk piston pumps can in particular be used. High-pressure pumps deliver a fixed volume of a fluid per revolution, regardless of the counterpressure.

The metering quantity (or volumetric flow) of the raw fuel can be specified in the present invention, for instance in a fuel cell vehicle, via an accelerator pedal.

In a preferred embodiment of the present invention, two pumps for metering the raw fuel conducted into the evaporating device are connected in series; the second pump is regulated, and the first pump runs continuously. By connecting the two pumps known from the prior art in series with one another, the requisite pressure for metering the raw fuel is achieved (in a pressure range up to 20 bar).

In a preferred embodiment of the present invention, these two pumps (optionally modified) are electric fuel pumps from the prior art. The delivery quantity is regulated by regulating the rpm of the second electric fuel pump by means of a timing module. The first electric fuel pump runs continuously. In the prior art, electric fuel pumps in continuous use (like the first pump) have already proven themselves in gasoline or Diesel operation, for instance. Using pumps from the prior art has the advantage that these electric fuel pumps, after a few modifications, can be produced economically and can be mass-produced.

In a further preferred embodiment of the present invention, these two pumps are a prefeed pump and a high-pressure pump. Pumps of the most various constructions from the prior art can be employed as the prefeed pump. The high-pressure pump is delivered with raw fuel by the prefeed pump. This provision is necessary only in the case of non-self-aspirating high-pressure pumps. In self-aspirating high-pressure pumps, no prefeed pump is required.

As the prefeed pump, an electric fuel pump preferably serves. In the prior art, electric fuel pumps in continuous use have proven themselves.

In one version of the present invention, a pressure damper damps the pressure pulsations, which have a feedback effect, that are caused by the at least one pump or by the system (such as the evaporator). By means of the pressure damper, the pressure pulsations are damped or even smoothed out. This has favorable effects on the reforming process.

A method for regulating the metering quantity of an electric fuel pump in a reforming system of the invention is also the subject of the present invention; a variable ascertained with a monitoring device serves as a controlled variable for the regulation. The regulation receives as a controlling variable the rpm of the regulated electric fuel pump, which is set by means of the timing module.

In a preferred embodiment of the regulating method of the invention, the counterpressure, measured with a pressure sensor, serves as the controlled variable for the regulation. The counterpressure in this connection is the pressure which becomes established at the output of the regulated electric fuel pump and thus at the input to the evaporating device. It increases as the metering quantity per unit of time increases. In a high-pressure pump, regulation via the counterpressure is not possible, since this pump pumps a fixed volume of raw fuel per revolution regardless of the counterpressure.

In a further preferred embodiment of the regulation method of the invention, the pulse width ratio of the trigger signal of the timing module serves as the controlling variable; a characteristic curve for the rpm, stored in memory in the control unit, as a function of the load state is compared with the rpm measured by the rpm sensor, and if there is a deviation, the rpm is varied via the pulse width ratio of the trigger signal of the timing module as a controlled variable.

The subject of the present invention is also a method for regulation of the metering quantity of a metering pump in a reforming system of the invention in which the metering quantity serves as the controlled variable. To that end, a characteristic delivery curve of the electric fuel pump is stored in memory in the control unit and indicates a set-point value for the metering quantity as a function of the rpm of the electric motor. Upon a deviation in the metering quantity from the set-point value, detected by a flow sensor, the rpm is varied as a controlling variable.

The subject of the present invention is also a method for monitoring a metering pump in a reforming system of the invention in a motor vehicle; upon a deviation of a variable, ascertained by the monitoring device, from a set-point value, a warning signal is output by a driver-information system. It is especially critical to warn the driver of the motor vehicle of a malfunction of the metering pump, since this can result in restricted travel, or even stoppage of the vehicle. The driver-information system may be the existing indicators in a motor vehicle in the prior art, such as warning lights, digital displays, and speakers. The warning signal can be imparted to the driver both visually and acoustically.

In a preferred embodiment of the monitoring method of the invention, the warning signal is output by the driver-information system if a monitoring device for monitoring the current consumption of the metering pump detects that a defined maximum or minimum current limit has been exceeded or undershot for longer than a defined length of time. Exceeding or undershooting these current limits can mean for instance that the electric motor or the pump is worn or is blocking, or that the coupling connection of the electric motor is loose. The result is an incorrect metering of the raw fuel. In such a case, a warning signal on the motor vehicle dashboard is for instance activated, such as a warning light and/or an indication to the driver that only restricted driving (emergency operation) is possible. If the electric motor or the pump blocks, a second warning light can be activated, which tells the driver that driving any farther is not possible. These visual warning signals can be reinforced by acoustic warning signals. Examples of acoustic warning signals are either individual tones or sequences of tones or text announcements. A text announcement says for instance “A serious malfunction has occurred. Please turn off your engine as quickly as possible”.

In a further preferred embodiment of the monitoring method of the invention, a warning signal is output by a driver-information system if the metering pump rpm, measured by an rpm sensor, deviates from the set-point value defined by a characteristic curve. The characteristic curve for instance describes the relationship between the pulse width ratio of the trigger signal of the timing module and the rpm of the electric fuel pump, which is regulated by the timing module, in normal operation and as a function of the load state. If the electric motor and/or the pump is sluggish, the measured rpm deviates from its set-point value, the latter being expressed by the characteristic curve. If threshold values stored in memory in the control unit are exceeded or undershot, a warning signal is activated. The warning signal is a display, a warning light, and optionally an acoustical warning sound. Thus the driver of the motor vehicle is made aware of the malfunction of the electric motor or pump.

In a further preferred embodiment of the monitoring method of the invention, a warning signal is output by a driver-information system if the metering quantity measured by the flow sensor deviates from its set-point value. A deviation can be caused by a malfunction of the electric motor and/or of the metering pump. In this case as well, the warning signal may include an acoustical and/or visual signal.

In a further preferred embodiment of the monitoring method of the invention, hazard-warning lights are activated in the motor vehicle, optionally in addition to the warning signal. The hazard-warning lights are intended to warn motor vehicles behind it that the motor vehicle may be about to stop. As a result, collisions can be avoided.

The subject of the present invention is also the use of the reforming system of the invention for metering a raw fuel for a fuel cell in a fuel cell vehicle.

### DRAWING

The invention will be described in further detail below in conjunction with the drawing.

Shown are:

FIG. 1, part of a reforming system of the invention, with two pumps;

FIG. 2, one embodiment of a reforming system of the invention, with a pressure sensor;

FIG. 3, a further embodiment of a reforming system of the invention, with a device for monitoring the current consumption of the electric motor, and a graph showing the set-point/actual-value comparison of the current;

FIG. 4, a further embodiment of a reforming system of the invention, with a flow sensor, and a graph showing the set-point/actual-value comparison of the metering quantity;

FIG. 5, a further embodiment of a reforming system of the invention, with an rpm sensor, and a graph showing the set-point/actual-value comparison of the rpm;

FIG. 6, a further embodiment of a reforming system of the invention, with an rpm sensor and a flow sensor;

FIG. 7, an embodiment of the rpm regulation of an electric fuel pump, in a reforming system of the invention; and

FIG. 8, a circuit diagram for a timing module for regulating an electric fuel pump in a reforming system of the invention.

### VARIANT EMBODIMENTS

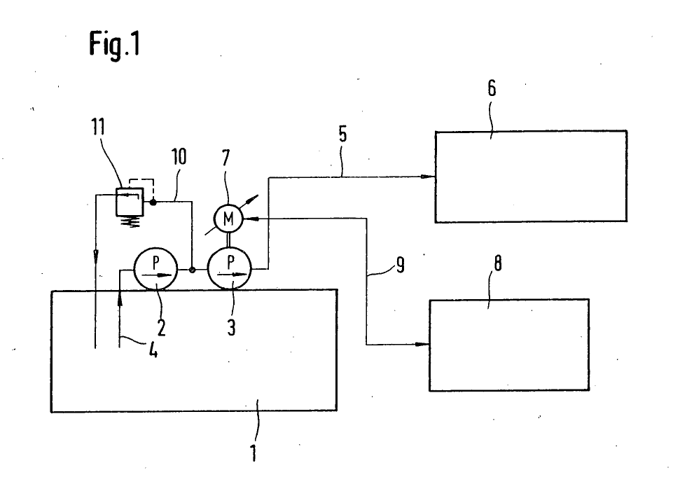

FIG. 1 shows part of a reforming system of the invention, with two pumps.

The reforming system includes a tank 1, which contains a raw fuel. It also includes two pumps 2, 3, which pump the raw fuel via the lines 4 and 5 into an evaporating device 6. In the case shown, these are a prefeed pump 2 and a high-pressure pump 3 driven by an electric motor 7. However, two electric fuel pumps connected in series would also be conceivable.

The quantity of raw fuel metered in the evaporating device 6 is regulated, in the embodiment shown of the present invention, via the rpm of the electric motor 7 of the high-pressure pump 3. A control unit 8, via a connection 9, triggers the electric motor 7 for regulating the rpm of the second pump 3. The prefeed pump 2 is for instance an electric fuel pump that is in continuous use. Its rpm is not regulated. Between the first electric fuel pump 2 and the second high-pressure pump 3, there is a return line 10, which communicates with the tank 1 via a pressure regulator 11. The pressure regulator 11 is for instance a check valve which limits the pressure at the outlet of the first electric fuel pump 2 to a maximum value. The quantity of raw fuel metered into the evaporating device 6 is monitored and regulated with the aid of at least one monitoring device (not shown).

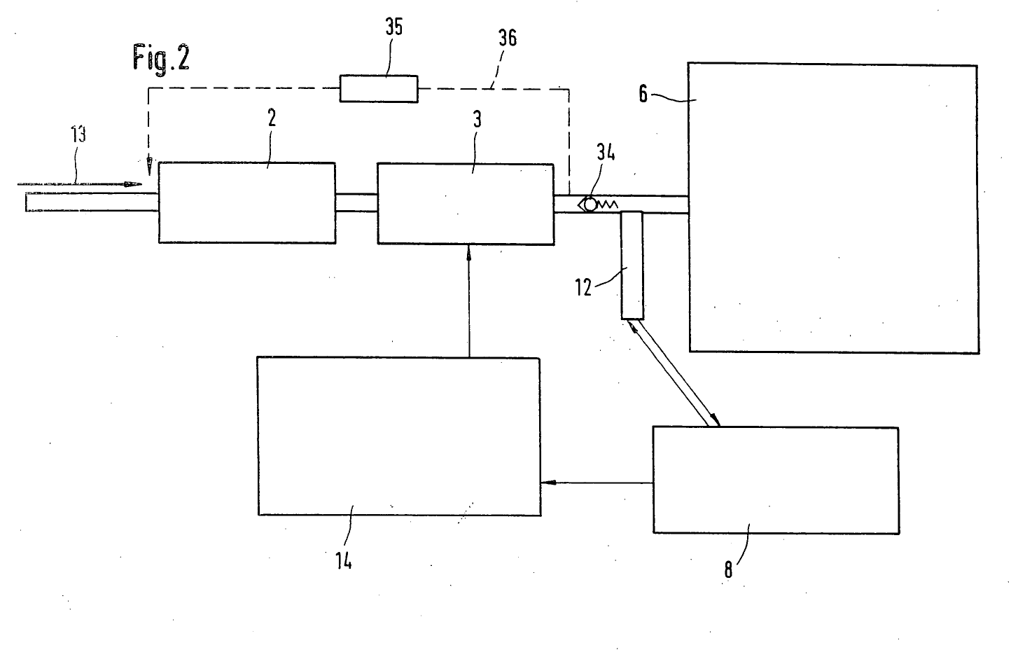

In FIG. 2, one embodiment of a reforming system of the invention with a pressure sensor is shown.

Two electric fuel pumps 2, 3 connected in series serve to meter the raw fuel into the evaporating device 6. In this preferred embodiment of the present invention, a monitoring device is a pressure sensor 12, which measures the counterpressure in the evaporating device 6. The pressure sensor 12 measures the counterpressure at the outlet of the second electric fuel pump 3. The counterpressure increases as the metering quantity increases per unit of time. Therefore, from the counterpressure measured with the pressure sensor 12, the metering quantity per unit of time (volumetric flow) can be determined (actual value) and compared with the set-point value sought for the metering quantity per unit of time (the volumetric flow). Consequently, the control unit 8 uses the signal of the pressure sensor 12 for regulating the quantity of raw fuel delivered by the electric fuel pump into the evaporating device 6. A pressure sensor known from the prior art can be used as the pressure sensor 12. Optionally, a check valve 34 between the second electric fuel pump 3 and the evaporating device 6 prevents a reverse flow into the pumps or an imposition of pressure on the pumps. Another possibility is fine regulation of the metering quantity by means of a proportional valve 35 located in a bypass 36. As a result, if the quantity delivered by the electric fuel pumps 2 and 3 is too high, some of the raw fuel delivered can be returned via the bypass 36. The proportional valve 35 may control only a portion (such as 10%) of the maximum delivery quantity. By means of the bypass regulation, it is possible to control the metering quantity with deviations of less than 2% from the set-point value.

As in the embodiment of the present invention shown in FIG. 1, the raw fuel 13 in FIG. 2 is metered into the evaporating device 6 via a first electric fuel pump 2 and a second, regulated metering pump 3 (in this case also an electric fuel pump). The measured values of the pressure sensor 12 are evaluated in the control unit 8. On the basis of these measured values, the control unit regulates the rpm of the second electric fuel pump 3 (and thus indirectly the volumetric flow of fuel) by means of a timing module 14.

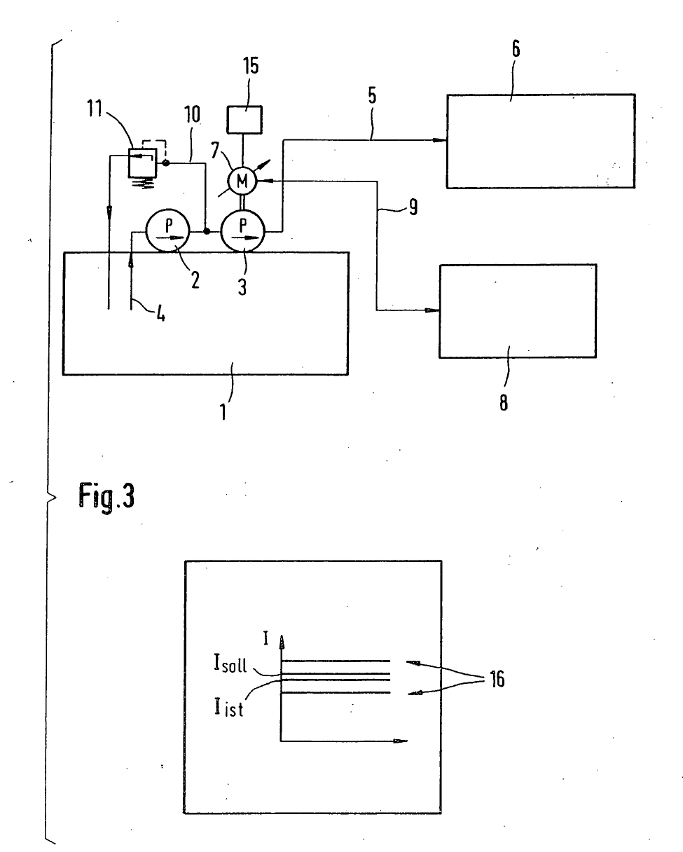

FIG. 3 shows a reforming system of the invention, with a device for monitoring the current consumption of the electric motor, and a graph showing the set-point/actual-value comparison of the current.

The reforming system shown in FIG. 3 is constructed as in FIG. 1. In addition, a current consumption monitoring device 15 measures the current consumption of the electric motor 7 of the second high-pressure pump 3. The measured current consumption is compared in the control unit 8 with characteristic curves. This kind of set-point/actual-value comparison is shown in the graph at the bottom of FIG. 3.

In this preferred embodiment of the present invention, a monitoring device 15 monitors the current consumption of the regulated metering pump 3. The monitoring of the current consumption of the electric motor of the high-pressure pump (or of the electric fuel pump used as the metering pump) is effected via the control unit 8. For instance, from the current, conclusions can be drawn about sluggish operation (wear) or shearing off of the coupling of the electric motor. If for certain load states, defined current threshold values 16 are exceeded or undershot for longer than a length of time Δt, this can be ascribed to a malfunction of the electric motor and/or of the electric fuel pump. The metering range (delivery quantity) and, given normal function of the pump 3 and motor, the resultant current consumption are defined as the load state.

In the graph at the bottom of FIG. 3, monitoring of the actual current value is shown for a defined load state (such as idling). The set-point value of the current I is located between the two threshold values 16. For regulating the pump 3, the actual current value Iᵢₛₜ is compared with the set-point current value Iₛₒₗₗ. If the actual value deviates from the set-point value, the current is reregulated. In this schematic example, the actual current value Iᵢₛₜ is between the two current threshold values 16, and so no malfunction is found. If conversely the upper threshold value is exceeded for longer than a time Δt, or the lower threshold value is undershot for longer than Δt, then it must be concluded that there is a malfunction of the electric motor 7 of one of the electric fuel pumps 2, 3.

The result of such a malfunction is defective metered quantities of raw fuel that are conducted into the evaporating device. If the current consumption of the electric motor drops sharply, then the motor runs idly; hence the coupling connection is loose, or the pump is worn. If the current increases above a maximum, this means a blockage of the electric motor or of the pump.

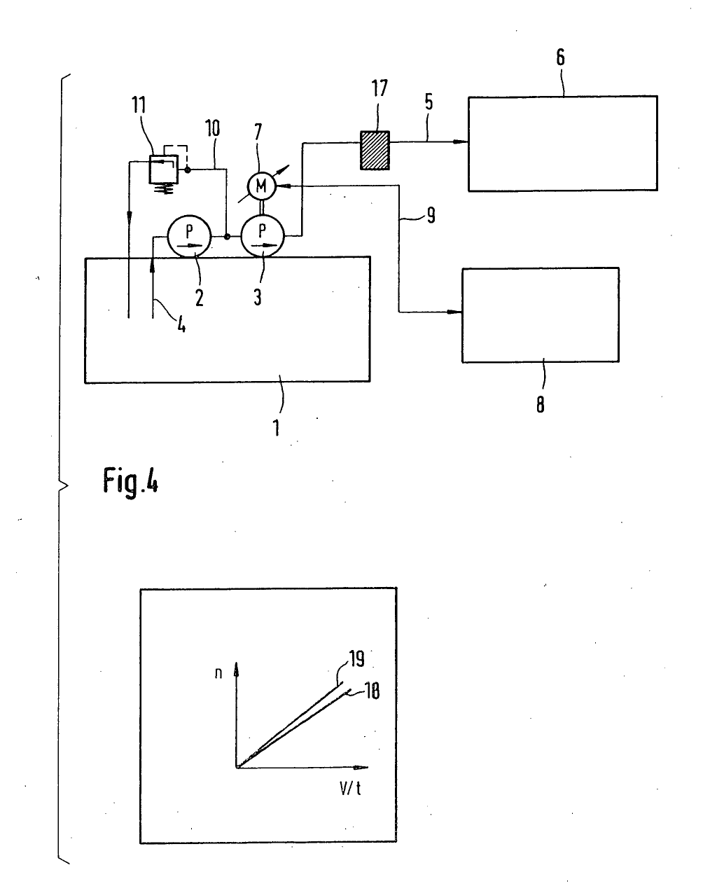

FIG. 4 shows a reforming system of the invention, with a flow sensor, and a graph showing the set-point/actual-value comparison of the metering quantity.

In this preferred embodiment of the present invention, a monitoring device is a flow sensor 17, which detects the metering quantity of raw fuel into the evaporating device 6. A characteristic delivery curve as a function of the rpm of the regulated metering pump 3 is stored in memory in the control unit, for instance, and the metering quantity measured with the flow sensor is compared with the desired specifications. A deviation of the actual metering quantity for a certain rpm of the pump from the characteristic delivery curve can for instance be the consequence of a change in concentration, an air inclusion, a leak, or wear. To avoid incorrect metering of the raw fuel into the evaporating device, the rpm of the pump can be suitably increased or decreased in the event of such a deviation. If the metering quantity is not increased or decreased as a result of this reregulation, then it must be concluded that there is a malfunction of the electric motor and/or of the regulated metering pump.

The graph at the top of FIG. 4 schematically shows the same construction as FIG. 1. In addition, the reforming system of the invention shown includes the flow sensor 17, which measures the metering quantity of raw fuel through the line 5 into the evaporating device 6. The measured metering quantity is compared, as shown in the lower part of FIG. 4, with desired specifications. This graph illustrates the relationship between the rpm n and the metering quantity (volume per unit of time: V/t) for a high-pressure pump. If the actual values 18 of the metering quantity deviate from the set-point characteristic curve 19, then the control unit 8 reregulates the rpm of the electric motor 7 in order to arrive at the set-point metering quantity.

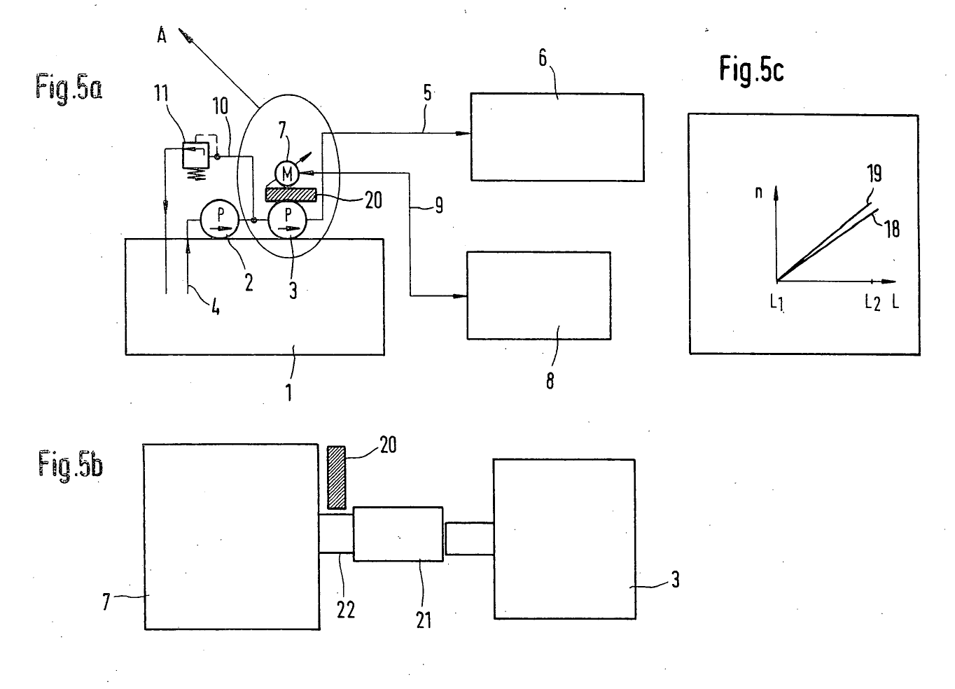

FIG. 5 shows a reforming system of the invention, with an rpm sensor, and a graph showing the set-point/actual-value comparison of the rpm.

In this preferred embodiment of the present invention, a monitoring device is an rpm sensor 20, which measures the rpm of the metering pump. In the case of electric fuel pumps, the rpm can be ascertained by means of an integrated Hall sensor, for instance, or indirectly by way of the current consumption in conjunction with the voltage. By means of a set-point/actual-value comparison with a characteristic curve stored in memory in the control unit 8 (rpm as a function of the load state), deviations of the actual rpm from its set-point value are detected.

If such a deviation occurs, conclusions can be drawn about sluggish operation of the electric motor and/or of the metering pump. An increase or decrease in the rpm is possible, if threshold values for the rpm are undershot or exceeded, respectively. The threshold values are typically available in the control unit.

FIG. 5a schematically shows a reforming system of the invention. It includes an rpm sensor 20, which measures the rpm of the electric motor 7 of a high-pressure pump. The detail A is shown enlarged in FIG. 5b. The electric motor 7 is connected to the second electric fuel pump 3 via a coupling 21. In this embodiment, the rpm sensor 20 is mounted on the motor shaft 22 so that it can pick up the rpm of the electric motor 7. However, it can be mounted instead at any other arbitrary point of the connection of the electric motor to the pump.

FIG. 5c shows a graph for the set-point/actual-value comparison of the rpm n. The measured rpm n is compared with desired specifications. This graph shows the dependency of the rpm n on the load state L. A set-point characteristic curve 19 is specified for all the load states L from idling L₁ to full load L₂. Upon a deviation in the actual rpm values 18 from the set-point characteristic curve 19, the control unit 8 reregulates the rpm of the electric motor 7 in order to reach the set-point metering quantity.

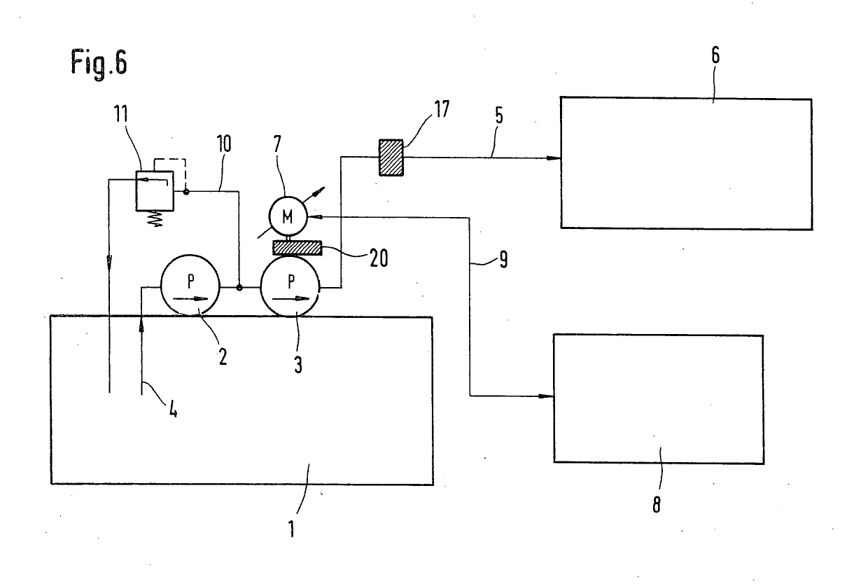

FIG. 6 shows a reforming system of the invention, with an rpm sensor and a flow sensor.

The rpm sensor 20 measures the rpm of the electric motor 7 of the high-pressure pump, and the flow sensor 17 measures the metering quantity into the evaporating device 6. Consequently, the reforming system of the invention may include one or more monitoring devices. A combination comprising a plurality of monitoring devices increases the functional reliability of the electric motor and of the regulated electric fuel pump and furthermore makes high-precision regulation of the volumetric flow of raw fuel into the evaporating device possible.

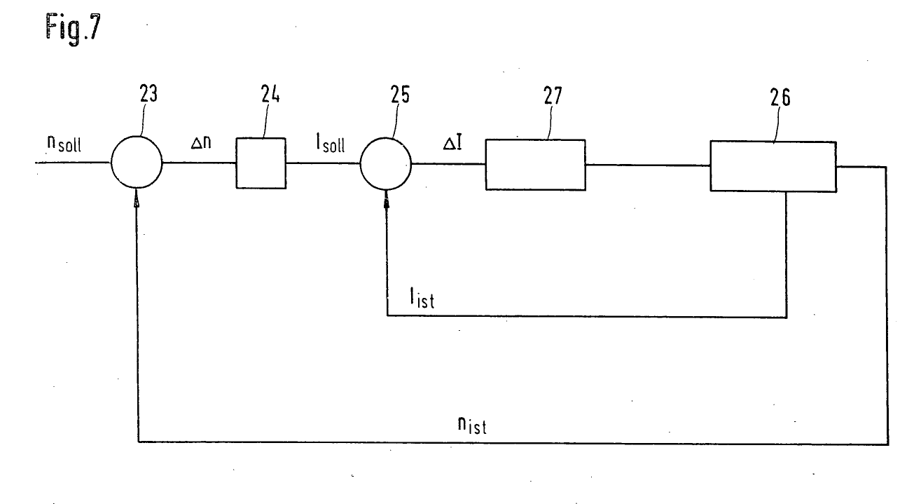

FIG. 7 shows an embodiment of the rpm regulation of an electric fuel pump, in a reforming system of the invention.

This involves a cascade regulation for the rpm. The rpm regulation includes two closed-loop control circuits: an “outer” closed-loop control circuit for rpm regulation, and an “inner” closed-loop control circuit for regulating current. The input variables for the “outer” control circuit are a set-point rpm nₛₒₗₗ and an actual rpm nᵢₛₜ. The actual rpm is detected by means of an rpm sensor. By the comparison 23 between the set-point and actual rpm values, an rpm difference Δn can be found, for instance when a different set-point rpm is specified. This rpm difference Δn is sent to a first PID controller 24, which converts it into a set-point current value Iₛₒₗₗ. In the “inner” control circuit, a comparison 25 of the set-point current value Iₛₒₗₗ with the actual current value Iᵢₛₜ of the pump motor 26 is made. The pump motor 26 is an electric motor, which drives the metering pump for metering the raw fuel. A resultant current difference ΔI between the set-point current value and the actual current value is compensated for by means of a second PID controller 27, which regulates the current for driving the pump motor 26. The “inner” control circuit serves, among other purposes, to compensate for transient problems, such as voltage dips or fluctuations in the commutator transition resistances. The “outer” control circuit serves to provide more-precise compensation of the set-point rpm (cascade regulation).

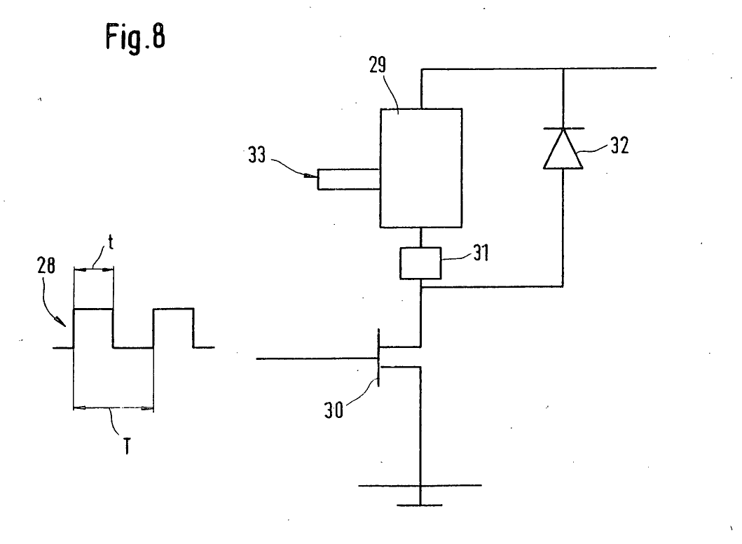

FIG. 8 shows a circuit diagram for a timing module for regulating an electric fuel pump in a reforming system of the invention.

A pulse width modulated signal 28 serves to trigger and regulate the electric fuel pump 29. The pulse duty factor t/T of the signal 28 of the ON duration t to the period duration T. The transistor 30, by way of which the current intensity through the armature coil of the electric fuel pump 29 is regulated, is clocked with the signal 28. Via a measuring resistor 31, the actual value of the current is determined. The regulation of the current is effected as described for the “inner” control circuit in FIG. 7. A free-wheeling diode 32 serves to protect the electric fuel pump 29. The rpm of the electric fuel pump can optionally be detected via a Hall sensor 33. This is an economical, small sensor that is implemented in the electric fuel pump.

### List of Reference Numerals

1 Tank
2 First pump
3 Second pump
4 First line
5 Second line
6 Evaporating device
7 Electric motor
8 Control unit
9 Connection
10 Return line
11 Pressure regulator
12 Pressure sensor
13 Raw fuel
14 Timing module
15 Current consumption monitoring device
16 Threshold values
17 Flow sensor
18 Actual values
19 Set-point characteristic curve
20 RPM sensor
21 Coupling
22 Motor shaft
23 Set-point/actual-value comparison for the rpm
24 First PID controller
25 Set-point/actual-value comparison for the current
26 Pump motor
27 Second PID controller
28 Pulse width modulated signal
29 Electric fuel pump
30 Transistor
31 Measuring resistor
32 Free-wheeling diode
33 Hall sensor
34 Check valve
35 Proportional valve
36 Bypass

1-20. (canceled)

21. A reforming system for a fuel cell, the system comprising
an evaporating device (6) for evaporating a raw fuel (13) and for delivering the evaporated raw fuel (13) to a reforming unit,
at least one pump for metering the raw fuel (13) that is conducted into the evaporating device (6),
a control unit (8),
at least one of said at least one pumps being a metering pump whose rpm is regulated by means of the control unit (8); and
at least one monitoring device serving to monitor the metering quantity of the raw fuel (13) through the at least one regulated metering pump.

22. The reforming system of claim 21, wherein at least one electric fuel pump serves as the metering pump.

23. The reforming system of claim 21, wherein a high-pressure pump driven by an electric motor (7) serves as the metering pump.

24. The reforming system of claim 21, wherein the at least one pump comprises first and second pumps (2, 3) connected in series, the second pump (3) being regulated while the first pump (2) operates continuously.

25. The reforming system of claim 24, wherein the first and second pumps (2, 3) are electric fuel pumps, and wherein the second electric fuel pump (3) is regulated by means of a timing module (14).

26. The reforming system of claim 24, wherein the first pump is an electric fuel pump (2) acting as a prefeed pump, and the second pump is a high-pressure pump (3).

27. The reforming system of claim 21, wherein the monitoring device is a pressure sensor (12), which measures the counterpressure in the evaporating device (6).

28. The reforming system of claim 21, wherein the monitoring device monitors the current consumption of the at least one pump (3).

29. The reforming system of claim 21, wherein the monitoring device is a flow sensor (17), which detects the metering quantity into the evaporating device (6).

30. The reforming system of claim 21, wherein the monitoring device is an rpm sensor (20), which measures the rpm of the at least one pump.

31. A method for regulating the metering quantity in an electric fuel pump (29) in a reforming system of claim 21, comprising the steps of ascertaining a variable with the monitoring device, which variable serves as a controlled variable for the regulation, and utilizing an rpm sensor to determine the rpm of the electric fuel pump (29) as a controlling variable for the regulation, the rpm being set by means of a timing module (14).

32. The method of claim 31, wherein the step of ascertaining a variable comprises measuring the counterpressure with a pressure sensor (12), which counterpressure serves as a controlled variable for the regulation.

33. The method of claim 31, wherein the pulse width ratio of the trigger signal of the timing module (14) serves as a controlling variable, utilizing an rpm sensor (20) to determine the rpm of the at least one metering pump, and comparing a characteristic curve of the rpm as a function of the load state, stored in memory in the control unit (8), with the rpm measured by the rpm sensor (20), and varying the rpm as a controlled variable by way of the pulse width ratio of the trigger signal of the timing module if there is a deviation between the characteristic curve and the measured rpm.

34. A method for regulating the metering quantity of a metering pump in a reforming system of claim 21, wherein the metering quantity serves as a controlled variable, and a characteristic delivery curve of the metering pump (3) is stored in memory in the control unit (8), which characteristic delivery curve indicates a set-point value for the metering quantity as a function of the rpm of the metering pump (3), and upon a deviation in the metering quantity from the set-point value, detected by a flow sensor (17), the rpm is varied as the controlling variable.

35. A method for monitoring a metering pump (3) in a reforming system of claim 21 used in a motor vehicle, comprising outputing a warning signal by means of a drive-information system upon a deviation of a variable, ascertained by the monitoring device, from a set-point value.

36. The method of claim 35, wherein the warning signal is output by the driver-information system if a monitoring device for monitoring the current consumption of the metering pump (3) detects that a defined maximum or minimum current limit has been exceeded or undershot for longer than a defined length of time.

37. The method of claim 35, wherein the a warning signal is output by a driver-information system if the rpm of the metering pump, measured by the rpm sensor (20), deviates from the set-point value defined by a characteristic curve.

38. The method of claim 34, further comprising outputing the a warning signal by a driver-information system if the metering quantity measured by a flow sensor (17) deviates from its set-point value.

39. The method of claim 35, wherein in addition to the warning signal, in the case of motor vehicle, hazard-warning lights are activated.

40. The method of using of a reforming system of claim 21, for metering a raw fuel to a fuel cell in a fuel cell vehicle.
